(19) United States
(12) Patent Application Publication
(10) Pub. No.: US 2019/0294154 A1
(43) Pub. Date: Sep. 26, 2019

(54) APPARATUS AND METHOD FOR AUTOMATIC CONTEXTUALIZATION AND ISSUE RESOLUTION RELATED TO INDUSTRIAL PROCESS CONTROL AND AUTOMATION SYSTEM

(71) Applicant: Honeywell International Inc., Morris Plains, NJ (US)

(72) Inventors: Andrew Duca, Phoenix, AZ (US); Bryan Anderson, Seattle, WA (US)

(21) Appl. No.: 15/926,886

(22) Filed: Mar. 20, 2018

(51) Int. Cl. G05B 19/418

(52) U.S. Cl. CPC G05B 19/4184; G05B 2219/31229; G05B 2219/31439

(57) ABSTRACT

A method includes receiving information associated with an event in an industrial process control and automation system, the information obtained from one or more sources of data related to the industrial process control and automation system. The method also includes determining whether the event has previously occurred. The method also includes responsive to the event previously occurring, generating a notification for a mobile end-user device using the received information associated with the event. The notification includes at least one resolution for the event.

### TECHNICAL FIELD

This disclosure relates generally to industrial process control and automation systems. More specifically, this disclosure relates to an apparatus and method for automatic contextualization and issue resolution related to an industrial process control and automation system.

### BACKGROUND

Industrial process control and automation systems are often used to automate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human operators routinely interact with controllers and other devices in a control and automation system, such as to review warnings, alarms, or other notifications and make adjustments to control or other operations.

### SUMMARY

This disclosure provides an apparatus and method for automatic contextualization and issue resolution related to an industrial process control and automation system.

In a first embodiment, a method includes receiving information associated with an event in an industrial process control and automation system, the information obtained from one or more sources of data related to the industrial process control and automation system. The method also includes determining whether the event has previously occurred. The method also includes responsive to the event previously occurring, generating a notification for a mobile end-user device using the received information associated with the event. The notification includes at least one resolution for the event.

In a second embodiment, an apparatus includes a memory configured to store at least one resolution. The apparatus also includes at least one processing device configured to receive information associated with an event in an industrial process control and automation system, the information obtained from one or more sources of data related to the industrial process control and automation system. The at least one processing device is also configured to determine whether the event has previously occurred. The at least one processing device is configured to use one or more queries to responsive to the event previously occurring, generate a notification for a mobile end-user device using the received information associated with the event. The notification includes at least one resolution for the event.

In a third embodiment, a non-transitory computer readable medium contains computer readable program code that, when executed, causes at least one processing device to receive information associated with an event in an industrial process control and automation system, the information obtained from one or more sources of data related to the industrial process control and automation system. The computer readable program code, when executed, also causes the at least one processing device to determine whether the event has previously occurred. The computer readable program code, when executed, also causes the at least one processing device to, responsive to the event previously occurring, generate a notification for a mobile end-user device using the received information associated with the event. The notification includes at least one resolution for the event.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial process control and automation system according to this disclosure;

FIG. 2 illustrates an example device for automatic contextualization and issue resolution related to an industrial process control and automation system according to this disclosure;

FIG. 3 illustrates an example context model for automatic contextualization and issue resolution related to an industrial process control and automation system according to this disclosure;

FIG. 4 illustrates an example system model for automatic contextualization and issue resolution related to an industrial process control and automation system according to this disclosure; and

FIG. 5 illustrates an example method for automatic contextualization and issue resolution related to an industrial process control and automation system according to this disclosure.

### DETAILED DESCRIPTION

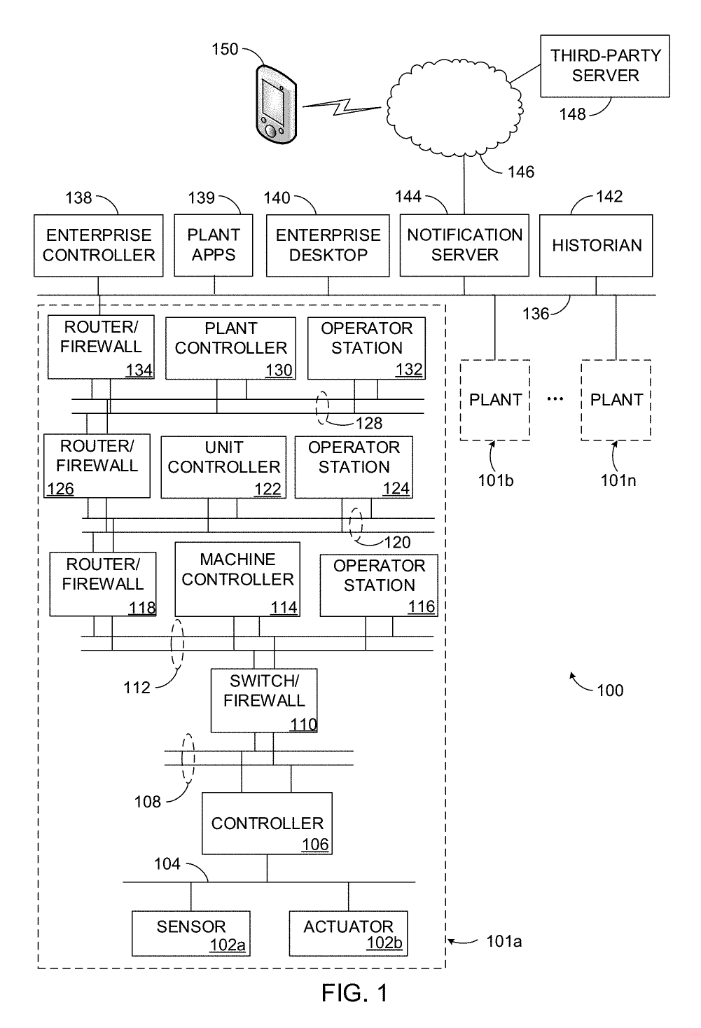

FIGS. 1 through 3, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Various plant applications 139 could also be executed in the system 100. In this example, the plant applications 139 are shown as residing on Level 5 of the system 100, although plant applications 139 could reside on other or additional levels of the system 100. The plant applications 139 could represent any suitable applications that are executed by server computers or other computing devices.

Access to the enterprise-level controllers 138 and plant applications 139 may be provided by one or more enterprise desktops (also referred to as operator stations) 140. Each of the enterprise desktops 140 includes any suitable structure for supporting user access and control of one or more components in the system 100. Each of the enterprise desktops 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 142 can be coupled to the network 136. The historian 142 could represent a component that stores various information about the system 100. The historian 142 could, for instance, store information used during production scheduling and optimization. The historian 142 represents any suitable structure for storing and facilitating retrieval of information. Although shown as a single centralized component coupled to the network 136, the historian 142 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 and each of the operator stations 116, 124, 132, 140 could include one or more processing devices and one or more memories for storing instructions and data used, generated, or collected by the processing device(s). Each of the controllers 106, 114, 122, 130, 138 and each of the operator stations 116, 124, 132, 140 could also include at least one network interface, such as one or more Ethernet interfaces or wireless transceivers, facilitating communication over one or more networks or communication paths.

The widespread use of mobile “smart” devices (such as APPLE IPHONEs and IPADs and ANDROID devices) allows users to remain connected and to interact with remote computing devices from virtually anywhere each user travels. Among other things, this could allow personnel associated with an industrial process control and automation system to receive warnings, alerts, or other notifications associated with events and other information and trigger actions associated with the control and automation system, regardless of whether the personnel are physically located at an industrial site. For example, events that are generated in a process control and automation system are often presented to operators currently on shift in one or more control rooms. There may also typically be a need or desire to inform users outside of control rooms, outside of an industrial plant, or while off network of events that are happening in the control and automation system. These events can come from a variety of applications, such as from a distributed control system (DCS) itself, advanced process control applications, operations applications, or business applications. Delivery of notifications describing these events to a user's handheld mobile device enables the user to receive notifications virtually anywhere and at any time.

To support this functionality, the system 100 includes a notification server 144, which receives data from other component(s) of the system 100 and generates notifications for users. For example, the notification server 144 could receive information identifying different events that occur with the system 100. The events could be associated with any suitable activities or conditions in the system 100, such as the generation of warnings or alerts by other components in the system 100. The notification server 144 could receive this information in any suitable manner and from any suitable source(s), such as from a historian, controller, or plant application. The notification server 144 uses this information to generate notifications (such as push notifications) and other messages to be sent to appropriate users. The notification server 144 could also provide additional information to appropriate users in response to user interactions with those notifications or other messages.

The notification server 144 communicates over a third-party network 146 with a third-party server 148. The third-party network 146 generally represents any suitable communication network(s) outside the system 100 (and therefore out of the control of the owners/operators of the system 100). The third-party network 146 could, for example, represent the Internet, a cellular communication network, or other network or combination of networks. The third-party server 148 represents a server used to provide notifications to end-user devices 150. For example, the third-party server 148 could push notifications to the end-user devices 150, allow retrieval of notifications by the end-user devices 150 at specified intervals or when requested, or provide notifications in any other suitable manner. The end-user devices 150 can then connect to the notification server 144 over the network 146 to receive details about notifications and events or to query for any notifications. As a particular example, the third-party server 148 could be used by companies like APPLE, SAMSUNG, or GOOGLE to provide push notifications or other notifications to mobile devices.

The end-user devices 150 denote any suitable user devices that can receive and present notifications to users. Examples of end-user devices 150 include smartphones, tablet computers, or other communication/computing devices. Specific examples could include APPLE IPHONEs, APPLE IPADs, and ANDROID devices.

In order to support the generation of notifications related to a process control and automation system, the notification server 144 implements a general-purpose event detection component that allows configurable queries to be registered with the server 144. The configurable queries are then executed to obtain information from one or more source systems (such as one or more controllers, historians, or other components in the system). The configurable nature of this detection component enables detection from source applications that are not natively built on a base platform or for which modification of the originating system is not possible. Upon receipt of information from a source system, the detection component generates one or more events that are processed by the platform and transformed into notifications, and the notifications can then be sent to at least one end-user device 150. Note that the events could also be generated by other components, and the notification server 144 could receive indications of those events rather than generating the events.

In this way, information about events associated with an industrial process control and automation system can be collected from a variety of sources and used to generate notifications for mobile end-user devices. This allows personnel to maintain situational awareness with respect to the control and automation system even when the personnel are outside of a control room or other typical work location.

The notification server 144 is able to operation in a manner to perform automatic contextualization and issue resolution. The notification server 144 is configured to receive information associated with an event in system 100. The information is obtained from one or more sources of data related to system 100. For example, the one or more sources may include devices 102. The notification server 144 is also configured to determine whether the event has previously occurred. The notification server 144 is also configured to, responsive to the event previously occurring, generate a notification for a mobile end-user device 150 using the received information associated with the event, wherein the notification includes at least one resolution for the event. The notification server 144 is also configured to, responsive to the event not previously occurring, generate the notification for the mobile end-user device using the received information associated with the event, wherein the notification does not include at least one resolution for the event.

In some embodiments, the at least one resolution is ordered by frequency of use by a users. The frequency of use may be determined based on feedback from the user. In some embodiments, the server may receive feedback, from the mobile end-user device, associated with one or more of the at least one resolution.

In various embodiments, the notification server 144 can determine, based on the feedback, whether the one or more resolution was implemented. A user may input this information in to the device 150 and then that information is sent to server 144. The server 144 can, responsive to the one or more resolution being implemented, update the one or more resolution with an additional frequency count. If the one or more resolutions is not being implemented, the server 144 can request, from the mobile end-user device, information on a new resolution that was implemented. In other words, if the one or more resolutions is not helpful or being implemented, a new resolution may have been used. The server 144 can send a request to the mobile end-user device for feedback on the at least on resolution.

A resolution can be defined as an answer to an issue or problem. In one embodiment, the resolution can be a way to fix a machine or device. In another example, the resolution can be a work around until the machine or device is fixed. In yet another example, a resolution can be simply replacing the machine or device. A resolution may also be a combination of the above. The server 144, responsive to receiving information on the new resolution, save the new resolution with the information. This way the new resolution can be used in future notifications.

Although FIG. 1 illustrates one example of an industrial process control and automation system 100, various changes may be made to FIG. 1. For example, a control and automation system could include any number of sensors, actuators, controllers, operator stations, networks, servers, end-user devices, and other components. Also, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which information related to an industrial process control and automation system can be collected and used to generate notifications for user devices. This functionality can be used in any other suitable system.

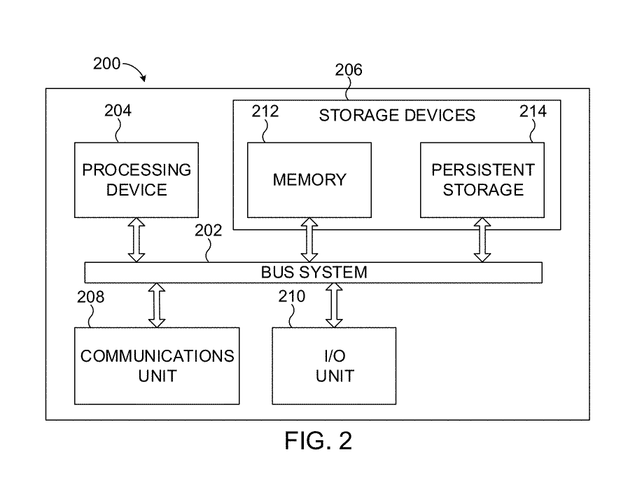

FIG. 2 illustrates an example device 200 for automatic contextualization and issue resolution related to an industrial process control and automation system according to this disclosure. The device 200 could, for example, represent the notification server 144 or the end-user device 150 in the system 100 of FIG. 1. However, the notification server 144 or the end-user device 150 could be implemented using any other suitable device or system, and the device 200 could be used in any other suitable system.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a ready only memory, hard drive, Flash memory, or optical disc.

The communications unit 208 supports communications with other systems or devices. For example, the communications unit 208 could include a network interface that facilitates communications over at least one Ethernet, HART, FOUNDATION FIELDBUS, or other network. The communications unit 208 could also include a wireless transceiver facilitating communications over at least one wireless network. The communications unit 208 may support communications through any suitable physical or wireless communication link(s).

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

When implementing the notification server 144, the device 200 could execute instructions used to perform any of the functions associated with the notification server 144. For example, the device 200 could execute instructions that implement at least one data access element with the ability to retrieve data from one or more source systems. The device 200 could also execute instructions that implement at least one polling component that interacts with the data access element(s) to retrieve information from the source system(s). The device 200 could further execute instructions that transform event information into notifications and that transmit the notifications for delivery to end-user devices 150.

When implementing the end-user device 150, the device 200 could execute instructions used to perform any of the functions associated with the end-user device 150. For example, the device 200 could execute instructions that process notifications and present information to users.

Although FIG. 2 illustrates one example of a device 200 for automatic contextualization and issue resolution related to an industrial process control and automation system, various changes may be made to FIG. 2. For example, components could be added, omitted, combined, further subdivided, or placed in any other suitable configuration according to particular needs. Also, computing devices can come in a wide variety of configurations, and FIG. 2 does not limit this disclosure to any particular configuration of computing device.

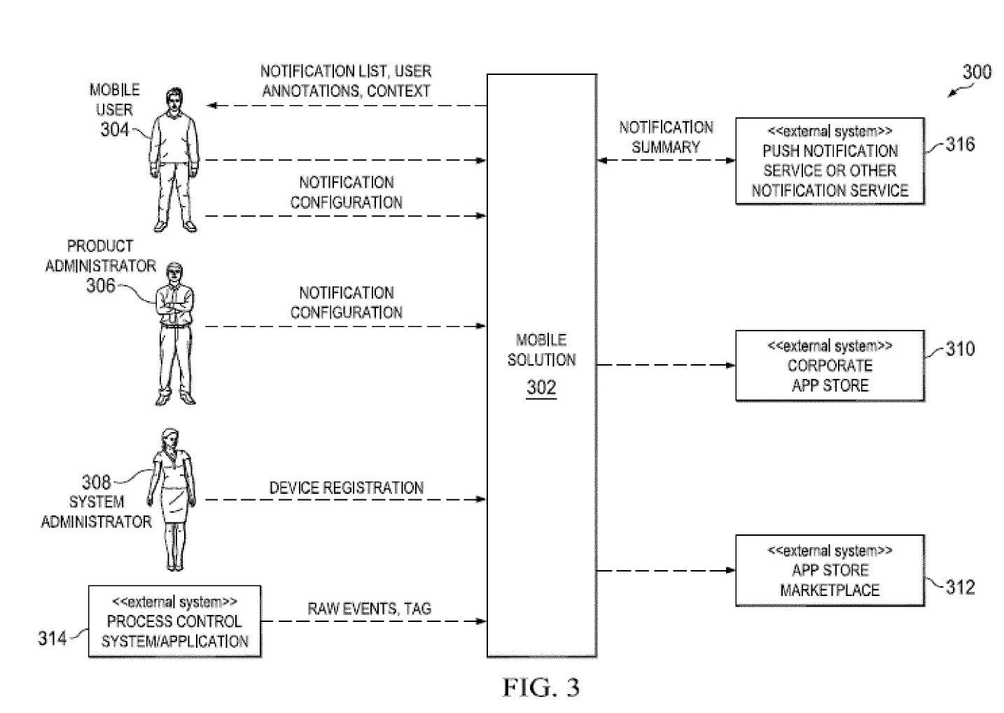

FIG. 3 illustrates an example context model 300 for automatic contextualization and issue resolution related to an industrial process control and automation system according to this disclosure. For ease of explanation, the context model 300 is described as being supported by the industrial process control and automation system 100 of FIG. 1. However, the context model 300 could be supported by any other suitable system.

As shown in FIG. 3, the context model 300 includes a mobile solution 302, which generally denotes at least part of the functionality of the notification server 144 and the application executed by the end-user devices 150. The mobile solution 302 interacts with three types of users 304-308 in this example, namely mobile users 304, product administrators 306, and system administrators 308. The mobile users 304 generally denote end users who use the end-user devices 150 to receive notifications and optionally act on those notifications. For example, the mobile users 304 could use the end-user devices 150 to review notifications regarding events in the industrial process control and automation system 100 and interact with other users to resolve undesirable or problematic situations in the system 100. Note, however, that the notifications could be used in any other suitable manner. The mobile users 304 could also have the ability to configure or control the notifications that are sent to those mobile users 304, such as by defining different rules used to generate the notifications.

The product administrators 306 represent users who configure the functionality of the mobile solution 302. For example, the product administrators 306 could define rules or other logic that control the generation of the notifications. As a particular example, the product administrators 306 could create rules that define the notifications sent in response to various events, the users who receive those notifications, and the contents of those notifications. In some embodiments, rules can be defined for different roles, and associations of users to those roles can be used to identify the mobile users 304 who receive notifications for those roles. As noted above, end users can also create their own rules for notifications, and the product administrators 306 could have the ability to review, modify, or delete the end user-created rules.

The system administrators 308 represent users who are responsible for allowing the mobile application executed by the end-user devices 150 to be authorized in their environment. For example, the system administrators 308 could grant permissions for end-user devices 150 to access the mobile solution 302 and register the end-user devices 150 with the mobile solution 302.

The application executed by the end-user devices 150 could be provided via an electronic store or marketplace, such as a corporate store 310 or a third-party store 312. Each electronic store 310-312 generally represents a computing system hosting one or more applications or “apps” that can be downloaded to the end-user devices 150. As the names imply, the corporate store 310 denotes a computing system operated by a corporation or other entity associated with the industrial process control and automation system 100 or other system. The third-party store 312 denotes a computing system operated by a third party unrelated to the industrial process control and automation system 100 or other system, such as APPLE or GOOGLE. End users can use their end-user devices 150 to access one or more of the electronic stores 310-312 and download an app that supports the use of notifications related to industrial process control and automation.

Once configured and placed into operation, the mobile solution 302 receives information about events from various sources, such as one or more process control systems or applications 314. Each process control system or application 314 could represent any component within the industrial process control and automation system 100 that can generate events or data indicative of events. In some instances, a process control system or application 314 can be designed to specifically integrate with the mobile solution 302, and the process control system or application 314 can itself provide events with or without tags (event-related information) to the mobile solution 302. In other instances, a process control system or application 314 may be unable to provide this information to the mobile solution 302 itself, and a plug-in or other mechanism can be used with the process control system or application 314 to identify events and transmit information to the mobile solution 302.

As the events are detected, the mobile solution 302 receives information about the events and uses rules or other logic to generate notifications for mobile users 304. The mobile solution 302 also sends the notifications to the end-user devices 150 of the mobile users 304. In some embodiments, the notifications are sent to the mobile users 304 directly via a third-party notification service 316, which could denote a service provided by the third-party server 148. The third-party notification service 316 could include an APPLE or ANDROID push notification service, although other push or non-push notification services could be used. The third-party notification service 316 provides the notifications to the end-user devices 150 used by the mobile users 304. Alternatively, the mobile solution 302 can generate obfuscated messages (such as unique alphanumeric codes, brief summaries, or other obfuscations) for the generated notifications, and the obfuscated messages can be sent to the third-party notification service 316 for delivery to the mobile users 304 as obfuscated notifications. The obfuscated notifications can be used by the end-user devices 150 to securely interact with the mobile solution 302 in order to obtain and present non-obfuscated notifications to the mobile users 304.

In whatever manner the notifications are provided to the end-user devices 150, the end-user devices 150 can present the notifications to the mobile users 304. For example, an end-user device 150 can receive and present a listing of notifications for a particular mobile user 304, where the listing identifies the notification messages, their associated identifiers, and some (or possibly all) of the fields of the notification messages. Annotations or other text-based communications associated with those notifications can also be provided to or received from the end-user device 150. Annotations could include communications such as comments from users or read receipts, forwarding indicators, or other system-generated annotations. In addition, context (such as detailed historical data for one or more process variables) can be provided to the end-user device 150. Note, however, that notifications can be used in any other suitable manner and that any other suitable data associated with the notifications can be sent to or received from the end-user devices 150.

Although FIG. 3 illustrates one example of a context model 300 for automatic contextualization and issue resolution related to an industrial process control and automation system, various changes may be made to FIG. 3. For example, additional types of users could be associated with the mobile solution 302, or functions of multiple user types could be combined. Also, while specific entities such as APPLE and ANDROID are described above, other stores or notification services could be used. In addition, various components could be added, omitted, combined, further subdivided, or placed in any other suitable configuration according to particular needs.

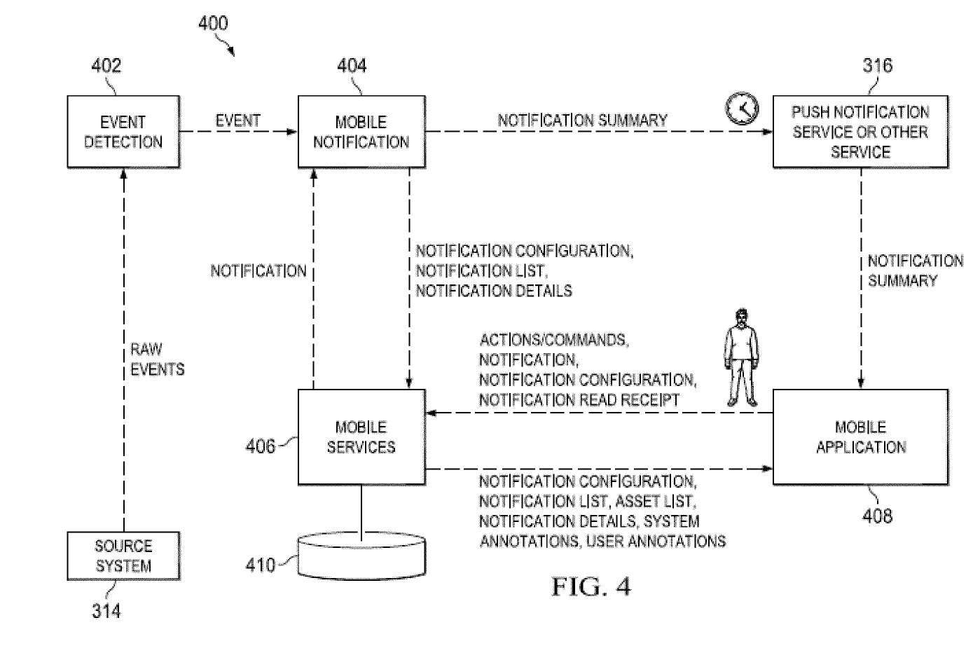

FIG. 4 illustrates an example system model 400 for automatic contextualization and issue resolution related to an industrial process control and automation system according to this disclosure. For ease of explanation, the system model 400 is described as being supported by the industrial process control and automation system 100 of FIG. 1. However, the system model 400 could be supported by any other suitable system. Also, in the following discussion, it is assumed that obfuscated notifications are sent to the end-user devices 150 via the third-party notification service 316 and that the end-user devices 150 request non-obfuscated notifications securely from the notification server 144. However, other mechanisms for providing notifications to the end-user devices 150 could be used, such as direct delivery of non-obfuscated notifications via the third-party notification service 316.

As shown in FIG. 4, the system model 400 includes an event detection unit 402, a mobile notification unit 404, and a mobile services unit 406. These units 402-406 could, for example, denote different functional units of the mobile solution 302. Each of the units 402-406 could be implemented using any suitable hardware or a combination of hardware and software/firmware instructions. For instance, each of the units 402-406 could be implemented using one or more software routines executed by the processing device(s) 204 of the notification server 144.

The event detection unit 402 receives information associated with events, such as from one or more process control systems or applications 314. The information associated with the events could include information such as a time of an event, a source of the event, a condition associated with the event, a category (such as minor, major, or critical) of the event, and a description of the event. The event detection unit 402 can obtain the information about the events in any suitable manner. For example, the event detection unit 402 could poll the process control systems or applications 314 at specified intervals, in response to triggering events, or at other times. The event detection unit 402 could also receive the information from plug-ins or other data collection components in or associated with the process control systems or applications 314 at specified intervals, in response to triggering events, or at other times. The events here could represent all events generated by the process control systems or applications 314 or only a subset of events generated by the process control systems or applications 314 (such as only certain types of events). The event detection unit 402 processes the information and outputs information identifying the events, such as in a standard format, to the mobile notification unit 404.

The mobile notification unit 404 receives the information identifying the events from the event detection unit 402 and generates obfuscated notifications for end-user devices 150. For example, the mobile notification unit 404 can generate non-obfuscated notifications containing suitable information about the events, generate unique identifiers for the non-obfuscated notifications, and generate obfuscated notifications that include the unique identifiers. The obfuscated notifications (referred to in FIG. 4 as notification summaries) are sent to the third-party notification service 316 for delivery to mobile applications 408. The mobile applications 408 represent an application executed by one or more end-user devices 150. The mobile notification unit 404 also provides various information, such as lists of notifications and the notifications themselves, to the mobile services unit 406.

The mobile services unit 406 interacts with each mobile application 408 securely, such as by using Virtual Private Network (VPN) or other secure communication protocol. The mobile services unit 406 performs various functions related to notifications. For example, the mobile services unit 406 could receive unique identifiers or other obfuscations from the mobile applications 408, retrieve non-obfuscated notifications associated with those obfuscations, and provide the non-obfuscated notifications to the mobile applications 408. The mobile services unit 406 can also manage lists of notifications that particular users have received, manage read-receipts for notifications that are read or viewed on the users' end-user devices 150, and allow rules to be configured by the end-user devices 150. The mobile services unit 406 can further provide user-generated or system-generated annotations to the end-user devices 150 and receive user annotations from end-user devices 150 for delivery to other end-user devices 150. In addition, the mobile services unit 406 can receive invocations of various commands from the end-user devices 150, such as commands for obtaining historical data, user comments, or other information about a specific notification.

Although FIG. 4 illustrates one example of a system model 400 for automatic contextualization and issue resolution related to an industrial process control and automation system, various changes may be made to FIG. 4. For example, various components could be added, omitted, combined, further subdivided, or placed in any other suitable configuration according to particular needs. Also, various components in FIG. 4 (such as components 402-406) could be implemented using a common device, or at least some of those components could be implemented using different devices.

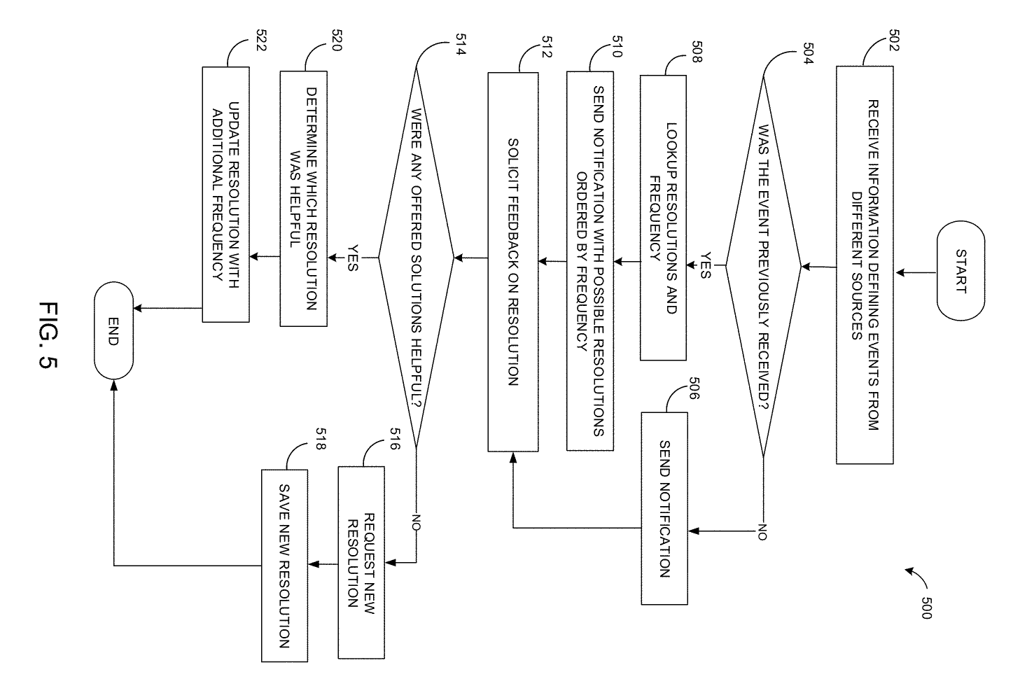

FIG. 5 illustrates an example method 500 for automatic contextualization and issue resolution related to an industrial process control and automation system according to this disclosure. The steps in FIG. 5 can be performed by notification server 144 as shown in FIG. 1.

As shown in FIG. 5, information associated with multiple events is received from multiple sources at step 502. This could include, for example, an event detection unit obtaining event information from multiple process control systems or applications and/or process historians 142.

At step 504, the notification server could determine whether any events were previously received. If an event has not been previously received, at step 506, the notification server sends a notification of the event to one or more user devices. The user devices can be predetermined based on the event. One or more rules can be used to identify one or more users to receive a notification associated with each event. Each rule could identify the condition(s) to be met in order to satisfy the rule and the contents of a notification to be generated if the condition(s) is/are satisfied. This could include generate a unique identifier or other obfuscation for each notification and interacting with the third-party notification service to transmit the obfuscation as part of an obfuscated notification to one or more end-user devices 150.

If the event has been previously received, at step 508, the server looks up the resolutions to that event and the frequency of the resolutions. At step 510, the server sends a notification to the device with the possible resolutions. In some embodiments, the resolutions are ordered by frequency of use.

At step 512, the server solicits feedback on one or more resolutions. In one example, the feedback is input by a user in response to the notification. In another example, the server sends a request for feedback. The feedback can include a verification of whether any of the suggested resolutions were helpful. A resolution may be helpful when it resolves the issue which generated the event. For example, if a component is malfunctioning and a suggested resolution was used to fix the device, then the resolution is helpful. At step 514, the server determines whether any of the offered solutions were helpful. The user may provide this information, or the information can come from the components related to the event.

If none of the solutions were helpful, at step 516 the server can request a new resolution from the device. In this example, the user may have performed a new resolution to resolve the event. The user can input the new resolution into the user device and that resolution can be sent to the server. At step 518, the server can save the new resolution.

If a resolution was helpful, at step 520 the server can determine which resolution was helpful. This determination can be based on feedback from the user or components related to the event. At step 522, the server can update the resolution with an additional frequency count.

Although FIG. 5 illustrates one example of a method 500 for automatic contextualization and issue resolution related to an industrial process control and automation system, various changes may be made to FIG. 5. For example, while each figure shows a series of steps, various steps in each figure could overlap, occur in parallel, occur in a different order, or occur any number of times. Also, each method could include any number of events, event information retrievals, and notifications.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving information associated with an event in an industrial process control and automation system, the information obtained from one or more sources of data related to the industrial process control and automation system;
determining whether the event has previously occurred; and
responsive to the event previously occurring, generating a notification for a mobile end-user device using the received information associated with the event, wherein the notification includes at least one resolution for the event.

2. The method of claim 1, further comprising:
responsive to the event not previously occurring, generating the notification for the mobile end-user device using the received information associated with the event, wherein the notification does not include at least one resolution for the event.

3. The method of claim 1, wherein the at least one resolution is ordered by frequency of use.

4. The method of claim 1, further comprising:
receiving feedback, from the mobile end-user device, associated with one or more of the at least one resolution; and
determining, based on the feedback, whether the one or more resolutions were implemented.

5. The method of claim 4, further comprising:
responsive to the one or more resolutions being implemented, updating the one or more resolutions with an additional frequency count.

6. The method of claim 4, further comprising:
responsive to the one or more resolutions not being implemented, requesting, from the mobile end-user device, information on a new resolution that was implemented; and
responsive to receiving the information on the new resolution, saving the new resolution with the information.

7. The method of claim 1, further comprising:
sending a request to the mobile end-user device for feedback on the at least one resolution.

8. An apparatus comprising:
a memory configured to store at least one resolution; and
at least one processing device coupled to the memory, the at least one processing device configured to:
receive information associated with an event in an industrial process control and automation system, the information obtained from one or more sources of data related to the industrial process control and automation system;
determine whether the event has previously occurred; and
responsive to the event previously occurring, generate a notification for a mobile end-user device using the received information associated with the event, wherein the notification includes at least one resolution for the event.

9. The apparatus of claim 8, wherein the at least one processing device is further configured to:
responsive to the event not previously occurring, generate the notification for the mobile end-user device using the received information associated with the event, wherein the notification does not include at least one resolution for the event.

10. The apparatus of claim 8, wherein the at least one resolution is ordered by frequency of use.

11. The apparatus of claim 8, wherein the at least one processing device is further configured to:
receive feedback, from the mobile end-user device, associated with one or more of the at least one resolution; and
determine, based on the feedback, whether the one or more resolutions was implemented.

12. The apparatus of claim 11, wherein the at least one processing device is further configured to:
responsive to the one or more resolutions being implemented, update the one or more resolutions with an additional frequency count.

13. The apparatus of claim 11, wherein the at least one processing device is further configured to:
responsive to the one or more resolution not being implemented, request, from the mobile end-user device, information on a new resolution that was implemented; and
responsive to receiving the information on the new resolution, save the new resolution with the information.

14. The apparatus of claim 8, wherein the at least one processing device is further configured to:
send a request to the mobile end-user device for feedback on the at least one resolution.

15. A non-transitory computer readable medium containing computer readable program code that, when executed, causes at least one processing device to:
receive information associated with an event in an industrial process control and automation system, the information obtained from one or more sources of data related to the industrial process control and automation system;
determine whether the event has previously occurred; and
responsive to the event previously occurring, generate a notification for a mobile end-user device using the received information associated with the event, wherein the notification includes at least one resolution for the event.

16. The non-transitory computer readable medium of claim 15, further containing computer readable program code that, when executed, causes the at least one processing device to:
responsive to the event not previously occurring, generate the notification for the mobile end-user device using the received information associated with the event, wherein the notification does not include at least one resolution for the event.

17. The non-transitory computer readable medium of claim 15, wherein the at least one resolution is ordered by frequency of use.

18. The non-transitory computer readable medium of claim 15, further containing computer readable program code that, when executed, causes the at least one processing device to:
receive feedback, from the mobile end-user device, associated with one or more of the at least one resolution; and
determine, based on the feedback, whether the one or more resolutions was implemented.

19. The non-transitory computer readable medium of claim 18, further containing computer readable program code that, when executed, causes the at least one processing device to:
responsive to the one or more resolutions being implemented, update the one or more resolutions with an additional frequency count.

20. The non-transitory computer readable medium of claim 18, further containing computer readable program code that, when executed, causes the at least one processing device to:
responsive to the one or more resolution not being implemented, request, from the mobile end-user device, information on a new resolution that was implemented; and
responsive to receiving the information on the new resolution, save the new resolution with the information.
